(19) United States
(12) Patent Application Publication
(10) Pub. No.: US 2005/0080854 A1
(43) Pub. Date: Apr. 14, 2005

(54) Internet-based system and method for providing selected information to recipients

(76) Inventor: Jay Tervo, Wilmington, NC (US)

Correspondence Address: WILLIAM J. MASON;MACCORD MASON PLLC, POST OFFICE BOX 1489, WRIGHTSVILLE BEACH, NC, 28480, US

(21) Appl. No.: 10/682,694

(22) Filed: Oct. 9, 2003

(51) Int. Cl. G06F 15/16

(52) U.S. Cl. 709/206; 709/203

(57) ABSTRACT

Communication between registered groups and registered users, is facilitated with a system in the form of an Internet accessible website that includes a first displayable web page for obtaining group registration information; a second displayable web page for obtaining user registration, the user registration information including a current email address; a third displayable web page accessible by registered users for registration with one or more groups as a group member; a forth displayable web page accessible by a group for posting messages at a designated time to registered members of the group; a database for storing information and messages posted by groups and users; and a computer program for periodically sending an email to each user containing messages posted by groups with which the user is registered.

### BACKGROUND OF THE INVENTION

(1) Field of the Invention

The present invention relates to a method and system in the form of an Internet accessible website for transmitting messages from a plurality of registered groups to a plurality of registered users in accordance with preferences provided by each user, and in particular to a method and website for sending electronic mail containing messages posted by registered groups to registered users at email addresses provided to the website by users, each email containing only messages posted by groups with which a user is registered.

(2) Description of the Prior Art

Organizations frequently need to advise a plurality of recipients, e.g., members and/or other potentially interested parties, of news, upcoming events, organizational changes, or other matters of possible interest. Messages concerning these matters can be made available to recipients via the Internet by posting the messages on a website operated by the organization or a third party. Alternatively, messages can be sent to the last-known electronic mail (email) address of each recipient. The email message can be the full message or a summary, e.g., the message title, advising the recipient of the posting of a message on the website.

These systems have disadvantages for both the organization and the recipient. Bulletin board type messages simply posted on a website are viewed only when the recipient accesses the website. Each recipient must frequently access the website just in case something of interest has been posted. Since the recipient may fail to check the website with sufficient regularity, messages may not be timely received.

Sending electronic mail to all potentially interested recipients requires the organization to maintain a database of recipients' current email addresses, and to take the time to periodically send information concerning the messages. In order to receive messages, recipients must remember, and take the time, to advise all the organizations to which the user subscribes of any new email address. Often, recipients change email addresses without advising an organization, resulting in the inability of the organization to successfully transmit messages. Also, the recipient must remove his or her email address from an organization's mailing list when the recipient is no longer interested in receiving information from the organization.

Thus, existing methods and systems of electronic communication do not enable organizations to provide messages to interested recipients in a timely and effective manner, and require considerable effort and time by both the organizations and recipients to maintain the desired communication links and eliminate unwanted communications. Therefore, there is a continuing need for an improved method and electronic system for transmitting messages from organizations to recipients.

### SUMMARY OF THE INVENTION

The present invention addresses this need by providing an electronic method and system enabling organizations to post messages to a single location, with recipients receiving messages only from organizations of interest. The method and system also enables the recipient to provide a single update of an email address with messages from a plurality of organizations being sent to the updated address.

Generally, the present invention operates over a Web-based system comprised of a server or web-hosting computer and a plurality of user-accessible client computers, i.e., desktop computers, laptop computers, PDAs, etc, joined in a network, e.g., the Internet, to the server computer. The invention is embodied in a website comprised of a plurality of files or programs that may be displayed as web pages maintained on the server computer and accessible via the Internet by a recipient using browser software, e.g., Microsoft Internet Explorer or Netscape Navigator software, installed in one of the client computers. The server computer may be accessed from client computers via modems, ISDN lines, telephone lines, wireless communications, etc.

The website of the present invention includes a means for organizations registering with the website (groups) to electronically post messages, a means for individuals who are registered with the website (users) to become a member of one or more groups of interest to the user (group member) to receive messages posted to the website by the group with which the user is registered (user's group), and a means for users to provide and update personal information, including a current email address. Preferably, each of these means is in the form of a browser accessible web page, which may include a form for data entry. The system also includes a database for storing information posted to the website, and a computer program for sending emails containing messages from a user's groups to group members at the last email address provided by the user.

The website may include optional means, such as a user directory that may be used for communications between users having common interests, and links to weather information, movie schedules, school lunch menus, etc. Other means common to interactive websites may also be included.

Groups registering with the website provide group information, such as the group name, a description of the group, and contact information. Other group details such as whether members of the group can obtain access to information about other group members, and whether membership in the group requires approval of the group administrator can also be defined. Optional questions to be answered by prospective group members can also be listed. The group information can be updated via a profile update web page.

Following registration, the group administrator is given access to a group administration page for posting to newsletters and announcements, events, etc. The administration page can also be used by the group administrator to access user profiles, and enable the administrator to compile email lists and mailing labels of registered users. A link can also be included to a group events page listing group events, and permitting editing of events, including relevant dates.

New users of the website are first required to complete a general website registration page, providing their name and contact information, a username and password, and an optional photograph in electronic, e.g., jpeg or gif, format. This information is stored in a database and can be subsequently accessed as a user profile page that can be updated by the user when there is a change in the user's email address or other data. The user is also provided with a list of available groups and information about each group, so that the user can register with groups of interest.

When the user joins a given group, the user is asked to designate which details of the website registration information will be provided to other group members. The user will also be asked to answer questions specific to the group. The user can later edit this group profile information via a profile update web page.

All group and user information provided through the above web pages are stored in a database on the server. Periodically, e.g., weekly, a computer program identifies the groups to which each user is registered, and determines which messages of each user's groups are currently scheduled to be sent to members. These messages are compiled into an email that is sent to the last email address provided by the user. Each email, which may be in HTML format, may contain messages in the form of brief summaries with hyperlinks advising the user of upcoming events or other announcements. Clicking on a hyperlink will access details of the announcement.

The email may also include a listing of the user's groups, with a link to each group. A link to a web page listing all of the website's registered groups may also be included so that the user can register with additional groups. The email also provides means for unsubscribing from a group. The link to a group, e.g., the group name as a hyperlink, accesses the group information page, which may contain a listing of upcoming events, information about the group, a listing of other group members, a textbox to send a message to the group administrator, a text box to send a message to other group members, and a link to the user's group profile page, permitting the user to update his or her group profile.

Groups can be related to various areas of possible interest to users, and may be for-profit or non-profit organizations. In a preferred embodiment, the groups are non-profit organizations within a particular geographic area, e.g., a city. These non-profit organizations may include performing arts groups, churches, civic organizations, hobby clubs, etc. The messages may include newsletters, upcoming events, membership information, other types of announcements, or summaries thereof.

### BRIEF DESCRIPTION OF THE DRAWINGS

FIG. 1 is a representation of a group profile editing web page.

FIG. 2 is a representation of a group membership registration web page.

FIG. 3 is a representation of a group administration web page.

FIG. 4 is a representation of a group events editing web page.

FIG. 5 is a representation of a user membership registration web page.

FIG. 6 is a representation of a user membership profile editing web page.

FIG. 7 is a representation of a user group registration web page.

FIG. 8 is a representation of a user group profile editing web page.

FIG. 9 is a representation of a user accessible group information web page.

FIG. 10 is a representation of a web page periodically sent as an email in HTML format to advise a user of upcoming group events.

### DETAILED DESCRIPTION OF THE INVENTION

It will be understood that the attached figures illustrate only one possible format of the web pages embodying the invention. The content, format and related graphics of the web pages may be modified in various ways without departing from the spirit and scope of the invention.

Generally, as illustrated in the preferred embodiment, the invention is a website and related method, the website being comprised of group web pages accessible by registered groups, and user web pages accessible by registered users. The group web pages enable groups to register with the website, update registration information, and provide information and messages to be accessed by group members. The user web pages enable users to register with the website, register with groups of interest, update website and group registration information, and receive information and messages provided by the user's groups. It will be understood that the website may also include additional pages, such as an index or “home” page, normally containing an introduction and description of the website, as well as links to other websites of possible interest.

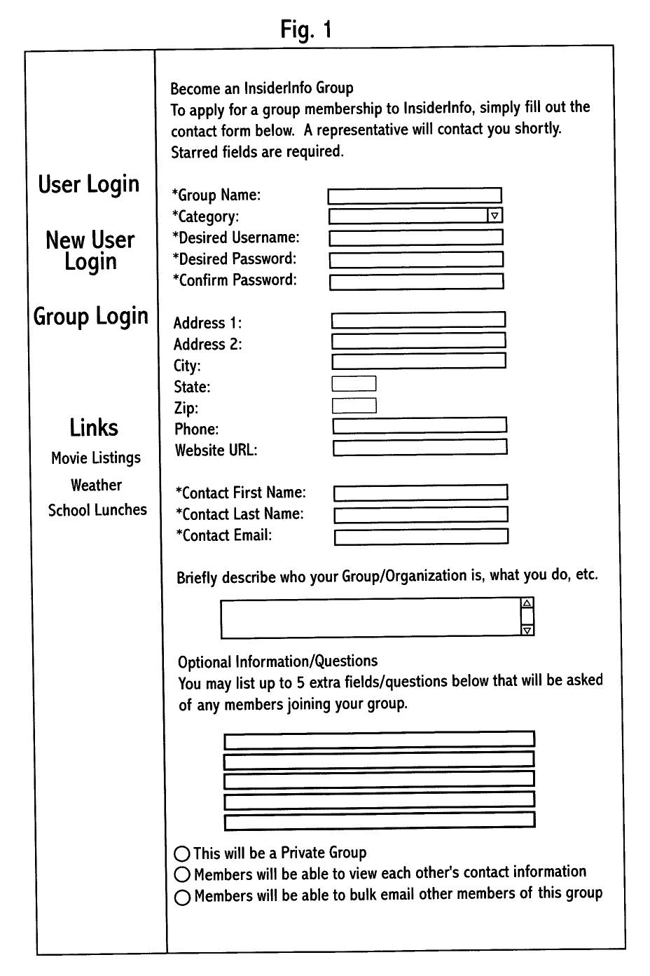

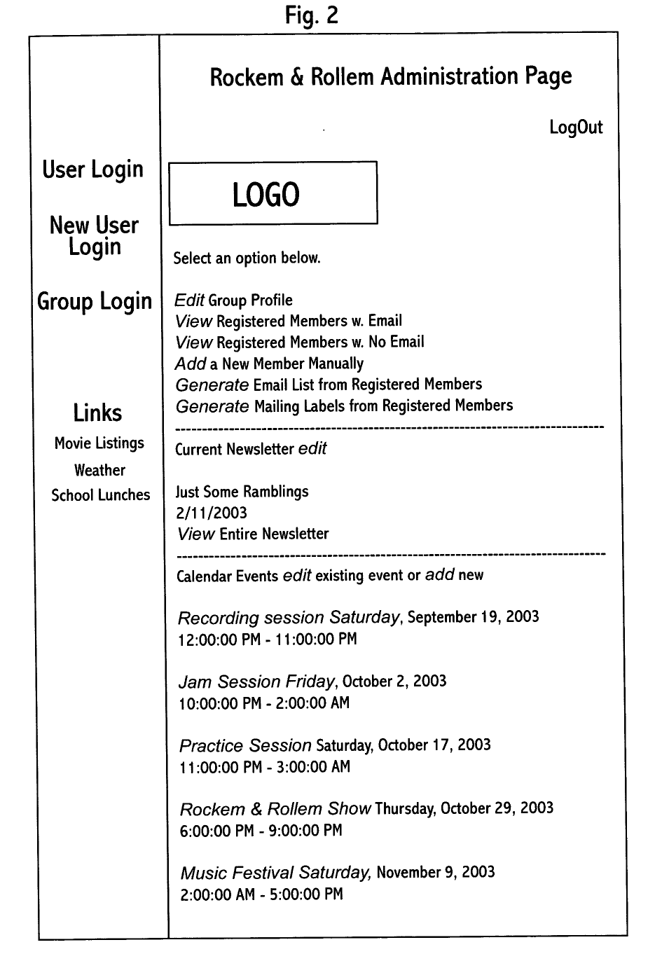

When an entity, such as a non-profit organization, wants to register with the website as a group, the entity first accesses the group membership registration web page illustrated in FIG. 1, and provides the group name and contact information, a requested username and password, and a brief description of the nature of the group. A category, e.g., arts, church, local business or music, is also selected. Questions or information to be provided by prospective members of the group can also be included. The group can be a public group available for membership by anyone, or a private group in which membership requires permission of the group administrator. The organization can also designate whether information about group members will be made available to other group members, and whether group members can bulk email other group members using the group membership information. FIG. 2 illustrates a web page accessible by username/password by the group administrator enabling the group administrator to update group information provided during registration.

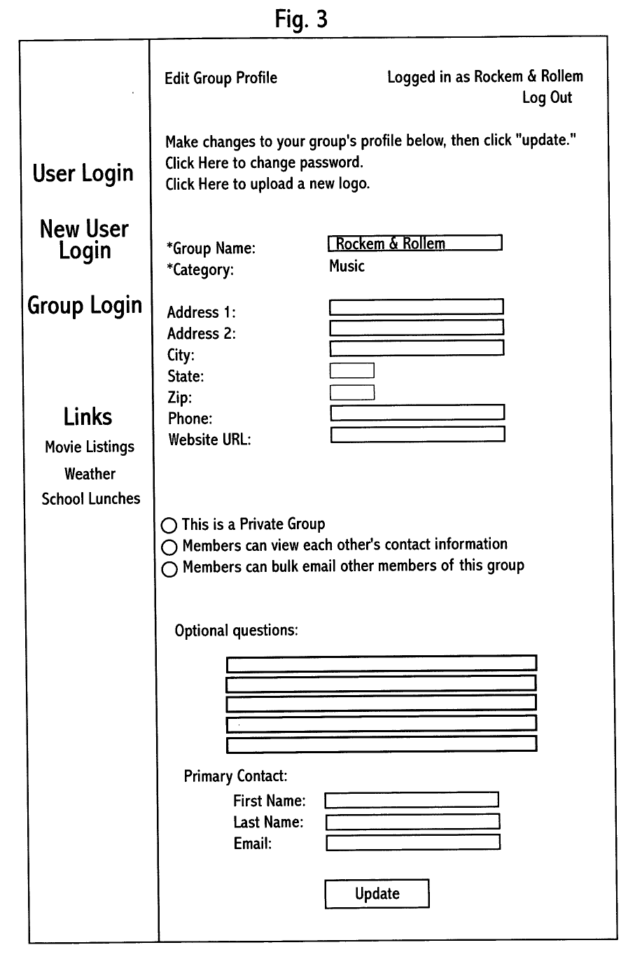

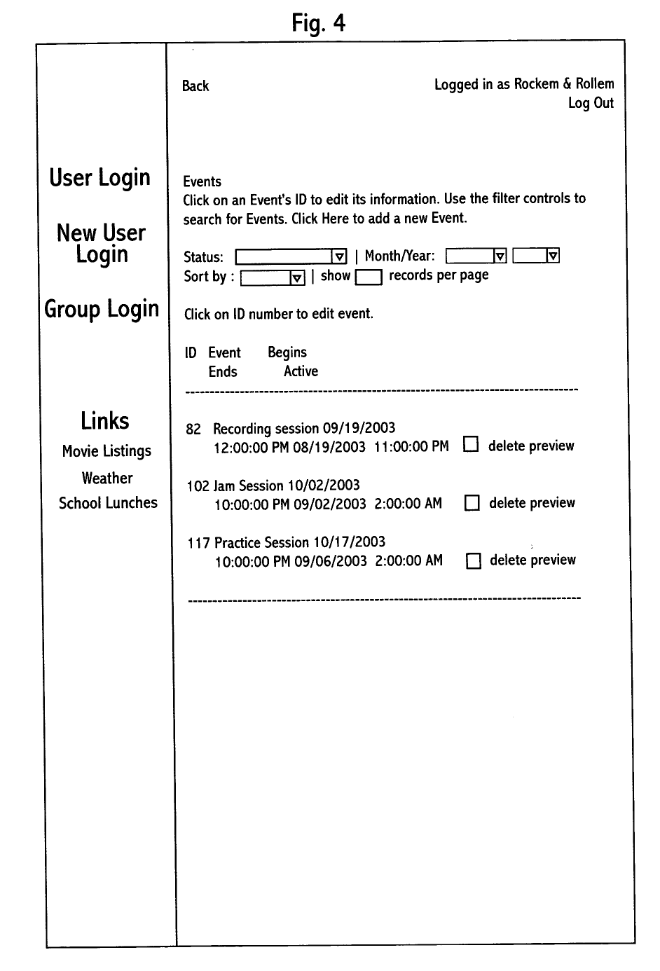

Following registration, the group administrator can post newsletters, announcements and other information to the website through a username/password accessible web page, such as illustrated in FIG. 3. Previously posted newsletters or announcements can also be edited. A separate web page can be provided, as illustrated in FIG. 4, to facilitate editing of the content and dates of all group events.

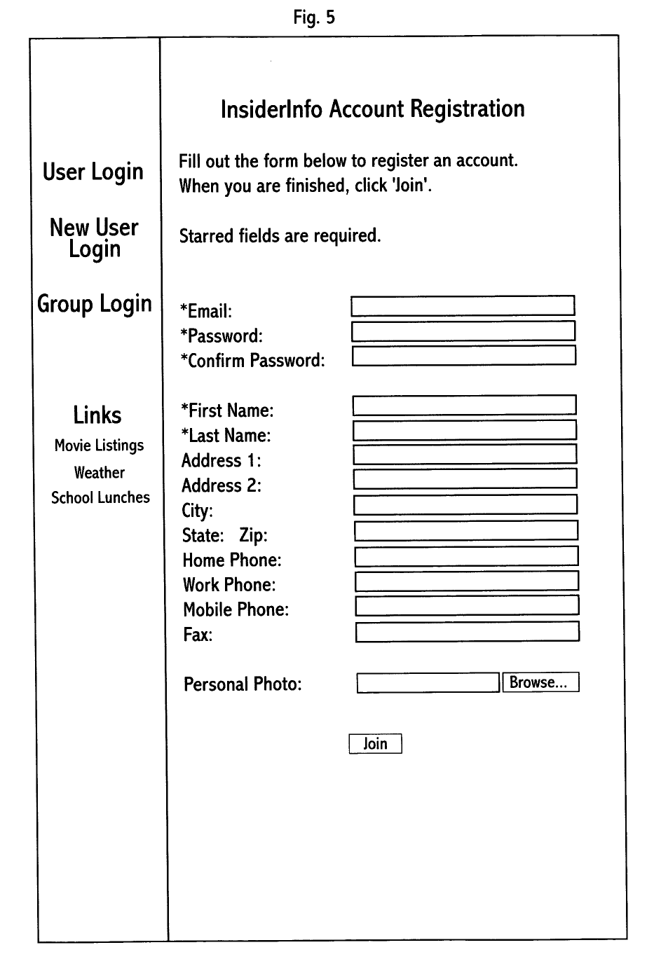

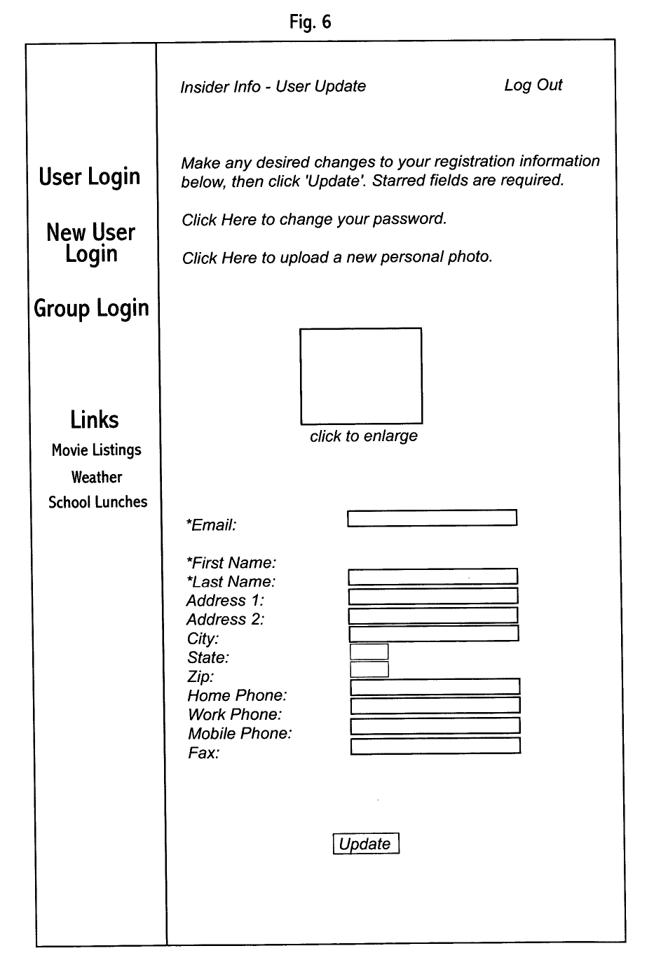

Prospective users of the website must first complete a user membership registration form as illustrated by the web page of FIG. 5. During registration, the user provides his or her name and contact information, including a current email address, and a requested username and password. A personal photograph may also be provided. This information may be updated from time to time using a username/password accessible user membership profile editing web page as illustrated by FIG. 6. Of particular importance is the fact that the user may change his or her email address to reflect the current email address to which emails from the website are to be sent. When the user membership is updated, the new information including any change of the email address is immediately stored in the website database and will be used for future emails until it is again changed.

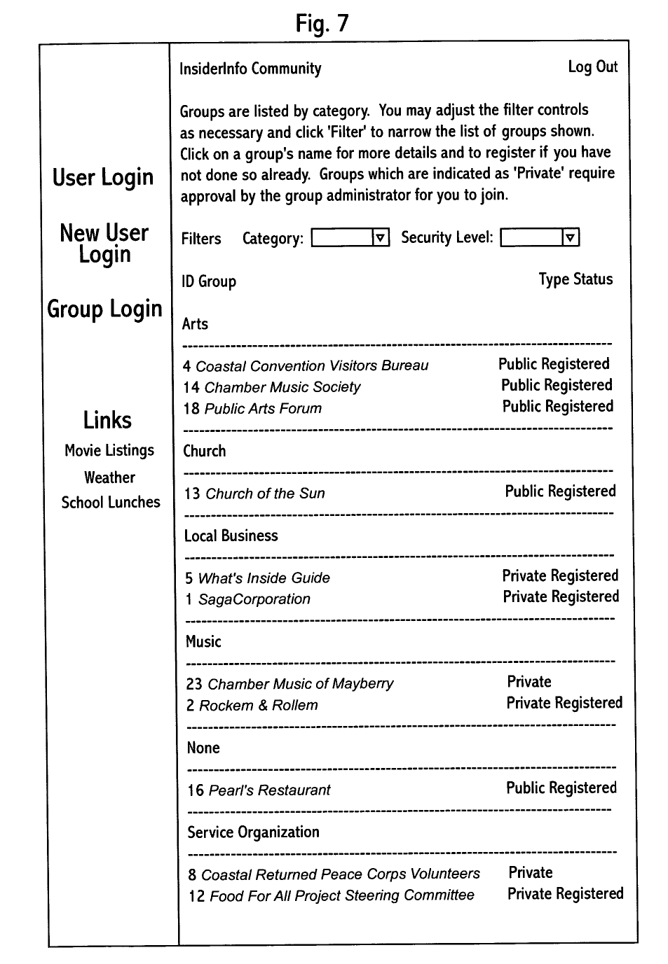

At any time following registration, a user can view information about groups registered with the website. FIG. 7 illustrates a web page suitable for this purpose. Upon accessing this web page, the user simply clicks on the name of the group of interest to view details of the group and register.

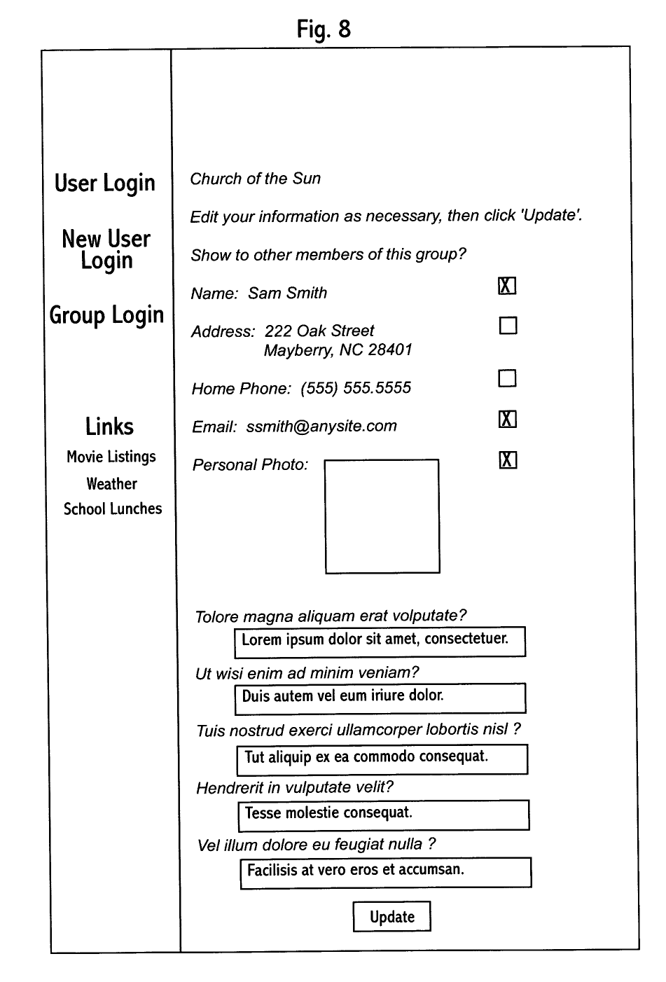

FIG. 8 illustrates a web page accessible by a group member to edit the user's profile with the registered group. The user group profile may include all or some of the information provided by the user when registering with the website. The user may be permitted to select what website registration information is made available to other group members. In addition, the user can provide answers to questions or responses to information requests added by the group administrator.

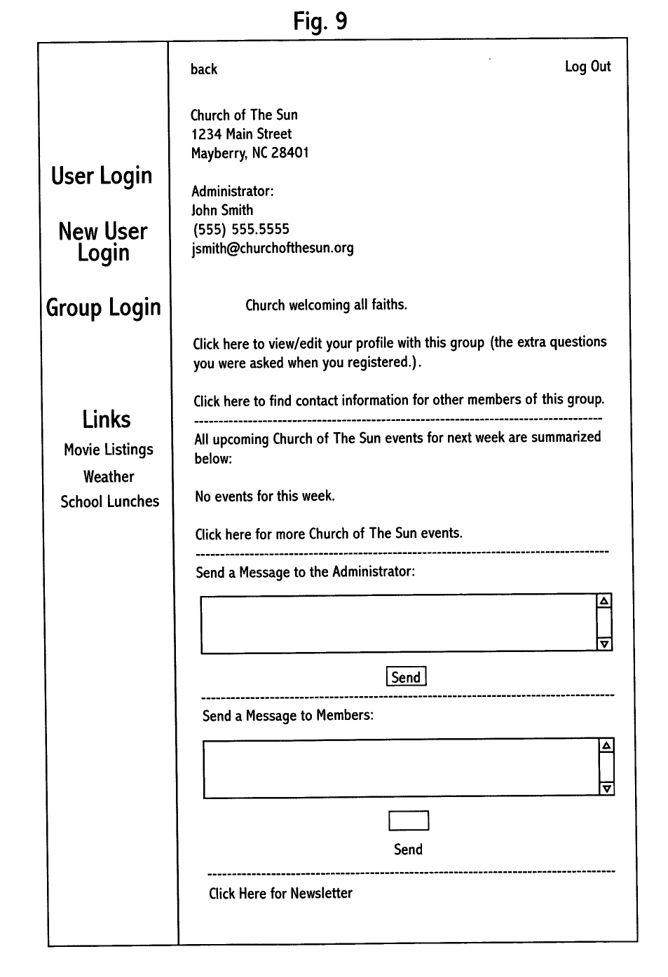

Once registered, the group member is given username/password access to the group information web page, where the group member can view announcements and the group newsletter, and send messages to the group administrator or to group members. A representative group information web page is shown in FIG. 9.

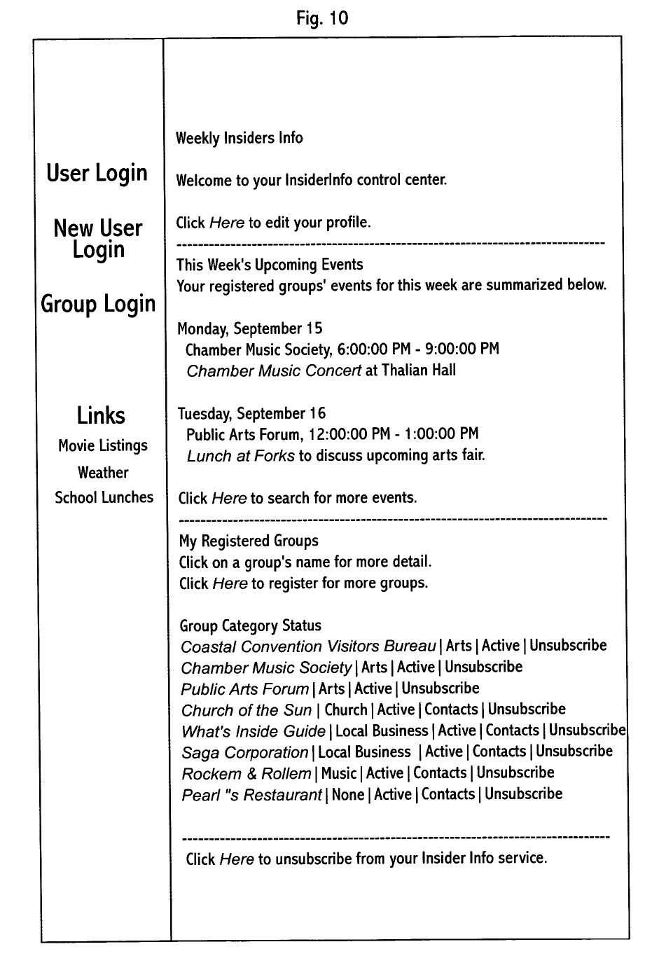

All information posted to the website by groups and users is stored in one or more databases on the server. The server also stores one or more computer programs or scripts, including an email program used to periodically send email messages, preferably in HTML format, to registered users. The email program periodically, e.g., weekly, selects a user from the list of registered users, compiles an email to the user comprised of messages designated by the user's groups to be posted during the given period, and sends the email to the user's last-designated email address. This process is repeated until emails are sent to all registered users. Upon receipt of an email, exemplified by FIG. 10, the user can view summaries of currently scheduled announcements from the user's groups, or click on an appropriate hyperlink in the email to obtain further information.

Since the program is set to run automatically at a set time period, and since the required information is provided by the groups and users, no intervention by the website administrator is required to send timely announcements to registered users. Moreover, since emails including information from all of the user's groups are sent in a single email to the user's last-designated email address, the need for each group to keep updated email address lists and to send emails to each member on the list is no longer required. Further, a user only needs to provide one update of his or her email address to continue receiving information from a plurality of groups, and can quickly and easily add or delete groups.

Certain modifications and improvements will occur to those skilled in the art upon a reading of the foregoing description. It should be understood that such modifications and improvements have been deleted herein for the sake of conciseness and readability but are properly within the scope of the following claims.

1. A method of transmitting messages from a plurality of groups to a plurality of users comprising:
a) receiving and storing messages posted by a plurality of groups;
b) receiving and storing a list of groups of interest and a current email address from each user; and
c) periodically sending to each user's current email address an email containing messages posted by the user's groups of interest.

2. The method of claim 1, wherein said email is in HTML format.

3. The method of claim 1, wherein said information includes hyperlinks to web pages maintained on a server.

4. The method of claim 1, wherein at least some of said groups are non-profit organizations.

5. The method of claim 1, wherein at least some of said messages relate to upcoming group-related events.

6. A method for facilitating communications between groups and users over an Internet accessible website, said method being comprised of:
a) receiving and storing group registration information from a plurality of groups;
b) receiving and storing user registration information from a plurality of users, said registration information including a designation of groups with which the user is registered, and the user's last-designated email address;
c) receiving and storing messages from each group, said messages including a time when said message is scheduled to be sent to registered user members; and
d) periodically sending an email to each user member at said current email address containing scheduled messages from groups with which the user member is registered.

7. The method of claim 6, wherein said messages are obtained from groups using a web page including a form for adding and editing messages, and a first database for storing said messages.

8. The method of claim 6, further including receiving an updated email address from one or more users.

9. The method of claim 6, further including receiving a change in group membership registration from one or more users.

10. An Internet accessible website for facilitating communications between groups and users, said website being comprised of:
a) a first means for receiving messages from each group;
b) a second means for receiving a last-designated email address and a list of groups with which a user is registered from each user; and
c) a third means for periodically sending an email to each user at the user's last-designated email address containing messages posted by the user's groups.

11. The website of claim 10, wherein said first means includes one or more browser accessible web pages including a form for adding and editing messages, and a first database for storing said messages.

12. The website of claim 10, wherein said second means includes one or more browser accessible web pages including forms for providing a user's current email address and a designation of the user's groups.

13. The website of claim 10, wherein said third means includes a computer program for periodically determining each user's groups, compiling an email to the user including messages posted by the user's groups and designated for current posting, and transmitting said email.

14. The website of claim 10, further including a group registration web page including means for designating information to be provided by prospective group members.

15. The website of claim 10, further including a user website registration web page and a web page enabling users to post a current email address.

16. The website of claim 10, further including an administration web page for use in adding and editing messages.

17. The website of claim 10, including a user website registration web page, and a user group registration web page for each registered group.

18. An Internet accessible website for facilitating communications between registered groups and registered users, said website being comprised of:
a) a first displayable web page including a form for obtaining group registration information from groups;
b) a second displayable web page including a form for obtaining user registration information from users, said registration information including the user's current email address;
c) a third displayable web page accessible by registered users including a form for use in registering as a group member with one or more groups;
d) a fourth displayable web page accessible by a group for posting messages to said website;
e) a database for storing information and messages obtained from groups and users; and
f) a computer program for periodically sending an email to each user containing messages posted by groups with which the user is registered.

19. The website of claim 18, wherein said computer program determines the groups with which the user is a member, selects messages posted by each of the user's groups that are designated for current posting, compiles an email to said user containing said messages, and sends the email to the user at the last email address specified by the user.

20. The website of claim 18, including group registration web pages for each of said groups, said registration web pages including a form requesting additional information to be provided by a user when registering as a group member.
